(19) United States
(12) Patent Application Publication
(10) Pub. No.: US 2024/0275476 A1
(43) Pub. Date: Aug. 15, 2024

(54) DETECTION AND AVOIDANCE OF INTERFERENCE

(71) Applicant: ADEMCO INC., Golden Valley, MN (US)

(72) Inventors: Nagaraj Chickmagalur LAKSHMINARAYAN, Bangalore, Karnataka (IN); Sachin JOY, Bangalore, Karnataka (IN); Arun Handanakere SHESHAGIRI, Bangalore, Karnataka (IN)

(21) Appl. No.: 18/567,404

(22) PCT Filed: Dec. 9, 2021
(86) PCT No.: PCT/US2021/062514

§ 371 Date: Dec. 6, 2023

(30) Foreign Application Priority Data
Jun. 8, 2021 (IN) 202141025537

(51) Int. Cl. H04B 7/212

(52) U.S. Cl. CPC H04B 7/212

(57) ABSTRACT

An apparatus for communication with a plurality of devices using time divisional multiple access (TDMA) is described. The apparatus includes processing circuitry configured to receive a signal from a device of the plurality of devices. The processing circuitry is further configured to determine, using the signal from the device, whether the device is experiencing signal interference. In response to determining that the device is not experiencing signal interference, the processing circuitry is configured to output a superframe including a first beacon at a first time, wherein the first beacon indicates a starting of the superframe. In response to determining that the device is experiencing signal interference, the processing circuitry is configured to output a time-shifted superframe including a second beacon at a second time that is different than the first time, wherein the second beacon indicates a starting of the time-shifted superframe.

### RELATED APPLICATION

This application is based upon and claims priority from Indian Provisional Patent Application No. 202141025537, filed on Jun. 8, 2021.

### TECHNICAL FIELD

This disclosure relates generally to networks, for instance, networks used in home automation, comfort, and security systems.

### BACKGROUND

A home network may use a wireless network protocol to connect devices within the home. For example, a hub device may use IEEE 802.15.4 to connect over one hundred sensor devices in a home to the hub device. The hub device may then collect sensor data collected by the sensor devices in the home. For instance, the hub device may collect door/window, or other security or home automation, sensor readings and output the door/window, or other security or home automation, sensor readings to a home security sensor or other device in the home network or, in some cases, to a remote server. In another instance, the hub device may collect temperature readings from multiple temperature sensors arranged within the home and output the temperature readings to a thermostat that controls an HVAC system using the temperature readings.

### SUMMARY

In general, this disclosure relates to systems, devices, and methods for wirelessly connecting devices using one or more (e.g., multiple) wireless protocols that use time-division duplexing, such as, for example, time-division multiple access (TDMA). As used herein, time-division duplexing can refer to processes that allocate each communication of multiple communications at a particular frequency (e.g., a 2.4 GHz band, a sub 1 GHz band) into a time “slot” of a repeating “superframe.” In contrast, frequency-division multiplexing can assign each communication of multiple communications to a unique frequency.

Techniques described herein may improve a performance of a network. For example, a hub device that utilizes TDMA protocols to connect devices can operate on a same band as other products that do not use TDMA. This means that the hub device is competing for network bandwidth with other devices, regardless of whether those other devices are configured to communicate with the same TDMA protocol. By determining whether the device outputting the signal is experiencing signal interference when outputting the signal, the apparatus can output a time-shifted superframe rather than continue the string of interference. As such, the ability to output time-shifted superframes can allow the hub device to support multiple sensor devices while also avoiding network traffic and noise from other devices that may be operating on the same frequency band or channel within that frequency band.

For example, processing circuitry can initially allocate a time slot for outputting superframes. In this example, the hub device may experience signal interference when outputting the superframes due to periodic or temporary noise, resulting in communication loss at the sensor devices. Once communication loss happens at the sensor end, all pending messages in the queue will be transmitted via non-TDMA protocols, with a high rate of retries. This process will continue until the sensor device re-connects to the hub device. Upon receiving the messages from the sensor device, the hub device may differentiate the type of transmission (e.g., non-TDMA) and number of retries of packets from each sensor device. The hub device may analyze the data to trigger one or more methods to detect and overcome the current interference. Once detected, the hub device may shift the slot at which the hub device outputs superframes to improve the chance of reception at sensor end by avoiding the interference. The hub device may either delay or advance the beacon transmission to overcome any overlapping of slots (e.g., TX-RX slots) for sensor communication. This drift will help the sensor device again to re-join to the hub device superframe and to continue its normal operation mode.

Network interference can lead to communication loss at the sensor device and can result in packet retires and periodic scans as an attempt to rejoin the network. This may lead to a loss of critical messages and more battery depletion at the sensor device. Sometimes this interference in the operating network can be intense at the sensor device as compared to the panel vicinity. This scenario can prevent the panel from detecting any interference in the network. By shifting the timing of outputting the superframes, techniques disclosed herein can provide a way to detect interference at the sensor device, by the hub device, and a method to overcome that signal interference. This can facilitate both reliability in transmitting messages between devices and increased battery life of the sensor device.

One embodiment includes an apparatus for communication with a plurality of devices using time divisional multiple access (TDMA). This apparatus embodiment includes processing circuitry configured to receive a signal from a device of the plurality of devices. The processing circuitry of this embodiment is further configured to determine, using the signal from the device, whether the device is experiencing signal interference. The processing circuitry of this embodiment is further configured to, in response to determining that the device is not experiencing signal interference, output a superframe including a first beacon at a first time, wherein the first beacon indicates a starting of the superframe. The processing circuitry of this embodiment is further configured to in response to determining that the device is experiencing signal interference, output a time-shifted superframe including a second beacon at a second time that is different than the first time, wherein the second beacon indicates a starting of the time-shifted superframe.

In a further embodiment of the apparatus, to determine, using the signal from the device, whether the device is experiencing signal interference, the processing circuitry is configured to determine if the signal received from the device matches a predefined signal interference criteria.

In one such example of this further embodiment of the apparatus, the predefined signal interference criteria includes a non-TDMA type signal. The processing circuitry of this embodiment is further configured to determine that the device is experiencing signal interference by determining that the signal received from the device is the non-TDMA type signal.

In another example of this further embodiment of the apparatus, the predefined signal interference criteria includes a retry signal. The processing circuitry of this embodiment is further configured to determine that the device is experiencing signal interference by determining that the signal received from the device is the retry signal.

In another example of this further embodiment of the apparatus, the predefined signal interference criteria is a predefined number of retry signals received from the device. The processing circuitry of this embodiment is further configured to determine that the device is experiencing signal interference by determining that the signal received from the device meets the predefined number of retry signals received from the device. In one such example of this further embodiment of the apparatus, the predefined number of retry signals received from the device is two or more retry signals.

In another example of this further embodiment of the apparatus, the predefined signal interference criteria includes both a non-TDMA type signal and a retry signal. The processing circuitry of this embodiment is further configured to determine that the device is experiencing signal interference by determining that the signal received from the device is both the non-TDMA type signal and the retry signal.

In a further embodiment of the apparatus, the processing circuitry is configured to use a same channel number to output each of the superframe and the time-shifted superframe.

In a further embodiment of the apparatus, the first beacon further indicates a group number assigned to each device of the plurality of devices, and the second beacon further indicates a group number assigned to each device of the plurality of devices.

Another embodiment includes a method. This method embodiment includes the step of receiving, at processing circuitry, a signal from a device of a plurality of devices. This method embodiment also includes the step of determining, at the processing circuitry using the signal from the device, whether the device is experiencing signal interference. This method embodiment also includes the step of, in response to determining, at the processing circuitry, that the device is not experiencing signal interference, outputting, by the processing circuitry, a superframe including a first beacon at a first time, wherein the first beacon indicates a starting of the superframe. This method embodiment also includes the step of, in response to determining, at the processing circuitry, that the device is experiencing signal interference, outputting, by the processing circuitry, a time-shifted superframe including a second beacon at a second time that is different than the first time, wherein the second beacon indicates a starting of the time-shifted superframe.

In a further embodiment of the method, determining, at the processing circuitry using the signal from the device, whether the device is experiencing signal interference includes determining if the signal received from the device matches a predefined signal interference criteria.

In one such example of this further embodiment of the method, the predefined signal interference criteria includes a non-TDMA type signal. This method embodiment also includes the step of determining that the device is experiencing signal interference by determining that the signal received from the device is the non-TDMA type signal.

In another example of this further embodiment of the method, the predefined signal interference criteria includes a retry signal. This method embodiment also includes the step of determining that the device is experiencing signal interference by determining that the signal received from the device is the retry signal.

In another example of this further embodiment of the method, the predefined signal interference criteria is a predefined number of retry signals received from the device. This method embodiment also includes the step of determining that the device is experiencing signal interference by determining that the signal received from the device meets the predefined number of retry signals received from the device.

In another example of this further embodiment of the method, the predefined signal interference criteria includes both a non-TDMA type signal and a retry signal. This method embodiment also includes the step of determining that the device is experiencing signal interference by determining that the signal received from the device is both the non-TDMA type signal and the retry signal.

In a further embodiment of the method, the superframe and the time-shifted superframe are output by the processing circuitry using a same channel number.

In a further embodiment of the method, the first beacon further indicates a group number assigned to each device of the plurality of devices, and the second beacon further indicates a group number assigned to each device of the plurality of devices.

An additional embodiment includes a system. This system embodiment includes a plurality of sensor devices and a hub device in communication with the plurality of sensor devices using time divisional multiple access (TDMA). The hub device includes processing circuitry configured to receive a signal from a device of the plurality of devices. The processing circuitry of this embodiment is further configured to determine, using the signal from the device, whether the device is experiencing signal interference. The processing circuitry of this embodiment is further configured to, in response to determining that the device is not experiencing signal interference, output a superframe including a first beacon at a first time, wherein the first beacon indicates a starting of the superframe. The processing circuitry of this embodiment is further configured to in response to determining that the device is experiencing signal interference, output a time-shifted superframe including a second beacon at a second time that is different than the first time, wherein the second beacon indicates a starting of the time-shifted superframe.

In a further embodiment of the system, to determine, using the signal from the sensor device, whether the sensor device is experiencing signal interference, the processing circuitry is configured to determine if the signal received from the sensor device matches a predefined signal interference criteria, and wherein the predefined signal interference criteria includes at least one of a non-TDMA type signal and a retry signal.

In a further embodiment of the system, the superframe and the time-shifted superframe are output by the processing circuitry using a same channel number.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1A is a conceptual diagram illustrating devices in communication using an initial superframe, in accordance with some examples of this disclosure.

FIG. 1B is a conceptual diagram illustrating devices in communication using a time-shifted superframe, in accordance with some examples of this disclosure.

FIG. 2A is a conceptual block diagram illustrating an example of a home network, in accordance with some examples of this disclosure.

FIG. 2B is a conceptual block diagram illustrating a hub device in greater detail, in accordance with some examples of this disclosure.

FIG. 3 is a conceptual block diagram of a hub device and a sensor device, in accordance with some examples of this disclosure.

FIG. 4 is a conceptual block diagram of a first example of slots of a single superframe, in accordance with some examples of this disclosure.

FIG. 5 is a conceptual timing diagram for beacons output in accordance with some examples of this disclosure.

FIG. 6 is a flow diagram illustrating a method, in accordance with some examples of this disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Modern residential buildings or other buildings may include a central “hub” device configured to manage one or more systems within the building, such as monitoring systems, comfort systems, security systems, and/or home automation systems. The hub device can be in wireless communication with a number of other devices placed throughout the building. For example, the hub device may wirelessly receive sensor data from any number of different sensor devices, such as motion sensors, air quality and/or temperature sensors, infrared sensors, door and/or window contact sensors, switches, and/or other sensor devices. Additionally, the hub device may wirelessly transmit commands or instructions to one or more controllable sensor devices. For example, the hub device may instruct a thermostat to adjust a temperature within the building, or in another example, may command a damper to open or close an air vent.

In some applications for managing one or more systems within a building, BLUETOOTH radio communication techniques may have an advantage over other radio connection techniques such as, for example, IEEE 802.15.4 radio communication techniques. For instance, BLUETOOTH radio communications techniques may support high data rates and throughput compared to IEEE 802.15.4 radio communication techniques. For example, BLUETOOTH may have a bandwidth of greater than 500 kilobits-per-second (kbps) (e.g., 1 Mbps) and IEEE 802.15.4 may have a bandwidth of less than 500 kbps (e.g., 250 kbps). From a range perspective, BLUETOOTH radio techniques and IEEE 802.15.4 radio communication techniques may have nearly equal link budget. BLUETOOTH may have a range of greater than 80 meters (e.g., 100 meters) and IEEE 802.15.4 may have a range of less than 80 meters (e.g., 70 meters). In some examples, BLUETOOTH may have a join time (e.g., latency) of greater than 1 second (e.g., 3 seconds) and IEEE 802.15.4 may have a join time of less than 1 second (e.g., 30 milliseconds (ms)). BLUETOOTH may have a stack size of greater than 100 kb (e.g., 250 kb) and IEEE 802.15.4 may have a stack size of less than 100 kb (e.g., 28 ms). In some examples, IEEE 802.11, also referred to herein as simply “Wi-Fi™,” may offer even higher data rates than BLUETOOTH but with a higher energy cost.

As used herein, BLUETOOTH may refer to present and future versions of BLUETOOTH. Examples of BLUETOOTH include classic BLUETOOTH (e.g., Versions 1.0, 1.0B, 1.1, 1.2, 2.0, 2.1, 3.0, 4.0, 4.1, 4.2, 5, 5.1, etc.), BLUETOOTH-low energy (e.g., Versions 4.0, 4.1, 4.2, 5, 5.1, etc.), and other types of BLUETOOTH. As such, all instances of “BLUETOOTH” herein should be interpreted as including classic BLUETOOTH and/or BLUETOOTH-low energy. BLUETOOTH may operate at frequencies between 2.402 and 2.480 GHz, 2.400 and 2.4835 GHz including a 2 MHz wide guard band and a 3.5 MHz wide guard band, or another frequency range. In some examples, each frequency channel of the BLUETOOTH channel may have a center frequency different from a central frequency of a neighboring channel by less than 1 MHz. In some examples, each frequency channel of a wireless channel (e.g., an IEEE 802.15.4 channel) may have a center frequency different from a central frequency of a neighboring channel by greater than 1 MHz (e.g., 2 MHz, 5 MHz, etc.).

In some cases, BLUETOOTH can refer to communications that use frequency hopping, such as, for example, frequency-hopping spread spectrum, to avoid interference from other radio communications. For example, a device using a BLUETOOTH channel may operate a BLUETOOTH channel that hops between 37 frequency channels when using advertising channels and 40 frequency channels when operating without advertising channels. In contrast, IEEE 802.15.4 may instead use a direct sequence spread spectrum technique. For example, a device may establish a wireless channel using IEEE 802.15.4 by mixing a signal for the wireless channel with a pseudo-random code which is then extracted by a receiver from an external device. Direct sequence spread spectrum may help to enhance the signal-to-noise ratio by spreading the transmitted signal across a wide band. In some examples, a device establishing a wireless channel using IEEE 802.15.4 may be configured to scan for a clear spectrum.

Smart home devices may deploy many different wireless protocols to address the needs to the smart home. There are standards based protocols (Wi-Fi™, ZigbeeM, Thread™, Zwave™, BLUETOOTH, DECT™, etc.) and proprietary, manufacturer specific protocols. The issue with this array of protocols is that each protocol is tuned to a specific application. For example, Wi-Fi™ may be particularly useful for high bandwidth data applications that do not require long battery life. Zigbee™ may be particularly useful for low bandwidth data applications to maximize battery life. Additionally, not every wireless protocol is globally compliant. For example, Zwave™ may have different hardware designs for various operational regions.

Smart home systems may include a collection of different networks that operate at a common frequency suitable for home networks. For example, a Wi-Fi™ network of a smart home system, a BLUETOOTH network of the smart home system, and an IEEE 802.15.4 network of the smart home system may each operate at a 2.4 GHz frequency. A hub device may allocate each device to a time slot, also referred to herein as simply “slot,” of the superframe (e.g., during a registration process). For example, the hub device may allocate a Wi-Fi™ slot to one or more first devices, a BLUETOOTH slot to one or more second devices, and an IEEE 802.15.4 slot to one or more third devices. In this example, the hub device may output the superframe using a beacon that specifies a beginning of the superframe. All devices of the network may synchronize to the beacon and output data at the 2.4 GHz frequency according to the allocated slots (e.g., relative to the beacon) of the superframe. For instance, the one or more first devices output data in accordance with the Wi-Fi™ protocol during the Wi-Fi™ slot, the one or more second devices output data in accordance with the BLUETOOTH protocol during the BLUETOOTH slot, and the one or more third devices output data in accordance with the IEEE 802.15.4 protocol during the 802.15.4 slot.

When smart home systems operate over any of these networks types, a common issue in typical systems is that these systems are rarely the only devices using a particular frequency on that network, or even a particular channel on the particular frequency. For instance, if the smart home system is configured to use the TDMA protocol to send superframes over a particular channel of the 2.4 GHz frequency in a Wi-Fi™ network, other computing devices within the home could also be sending messages or making noise on that same channel. This interference in the signal output by the hub device leads to the various sensor devices initiating battery-intensive scans to re-connect with the hub device and to output messages outside of the TDMA protocol, causing the sensor device to lose the various benefits provided by the TDMA protocol and to lose battery efficiency.

In accordance with the techniques of this disclosure, rather than continuing to output superframes in accordance with the initial timing period, a hub device will time-shift the superframes forward or backward from the initial schedule in an effort to avoid periodic noise output by other devices utilizing the same network as the hub device. If the hub device receives a signal that indicates signal interference over the network, the hub device will output a time-shifted superframe, potentially still over the same channel and with the same contents, in an effort to reduce scans performed by the sensor devices that may miss the superframe amongst the noise if the schedule were maintained. A hub device that dynamically adjusts the timing at which it outputs a superframe may increase a bandwidth of the network and battery efficiency of the corresponding sensor devices as compared to hub devices that can only operate according to the set schedule.

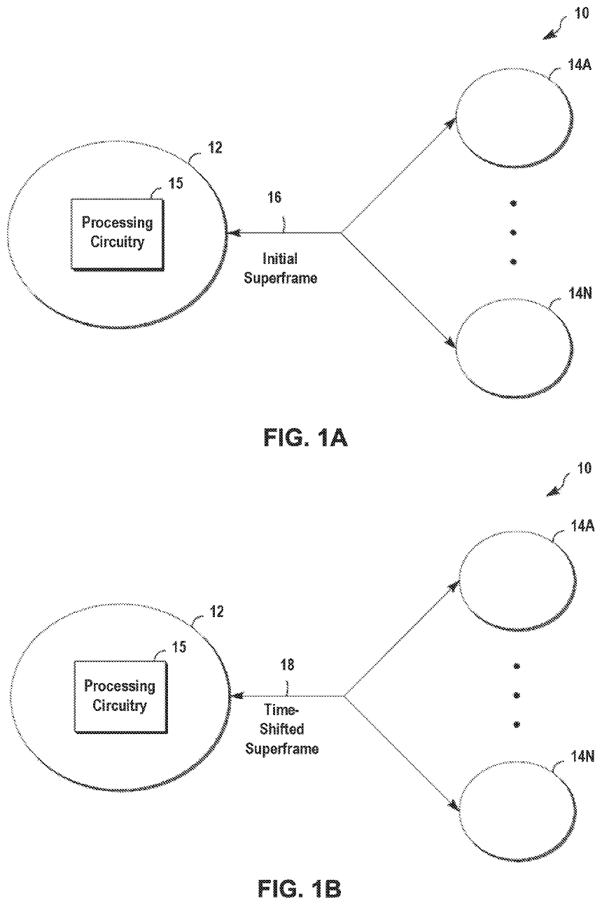

FIG. 1A is a conceptual diagram illustrating devices in communication using an initial superframe, in accordance with some examples of this disclosure. In some examples, the initial superframe is a time divisional multiple access (TDMA) superframe. While system 10 illustrates only hub device 12 and sensor devices 14A-14N (collectively, “sensor devices 14” or simply “devices 14”), system 10 may include additional devices (e.g., devices in wireless communication with each other) or fewer devices. System 10 may be installed within a building and the surrounding premises (collectively, “premise”).

Hub device 12 may include a computing device configured to operate one or more systems within a building, such as comfort, security, safety, and/or home automation systems. For example, as described further below, hub device 12 may include processing circuitry 15 configured to receive data, such as data received from one or more devices and/or from user input, and process the data in order to automate one or more systems within a building. For example, hub device 12 may automate, control, or otherwise manage systems including heating and cooling, ventilation, illumination, or authorized access to individual rooms or other regions, as non-limiting examples. For example, hub device 12 may include a “Life and Property Safety Hub®” of Resideo Technologies, Inc.®, of Austin, Texas. Hub device 12 may include a wired connection to an electric power grid, but in some examples may include an internal power source, such as a battery, supercapacitor, or another internal power source.

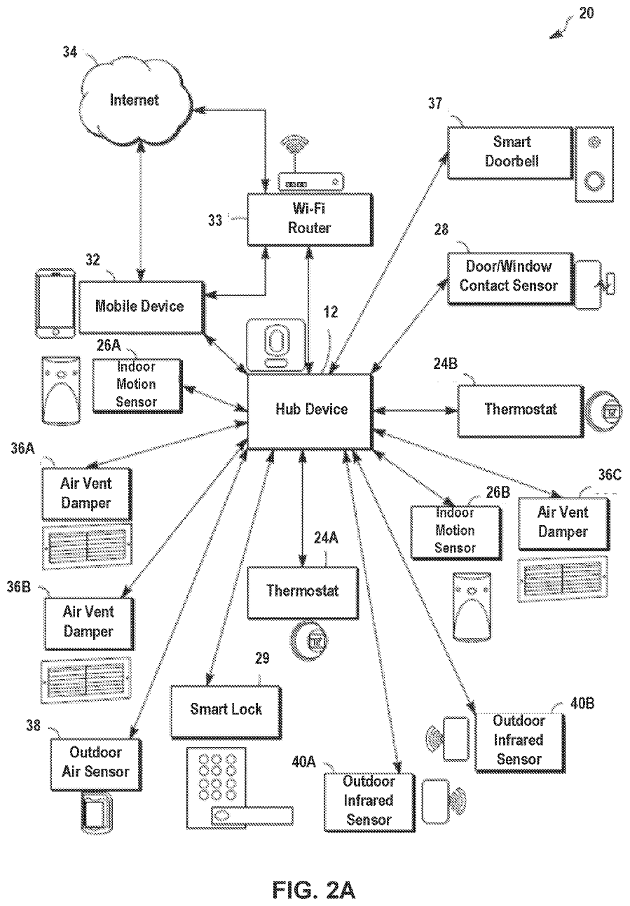

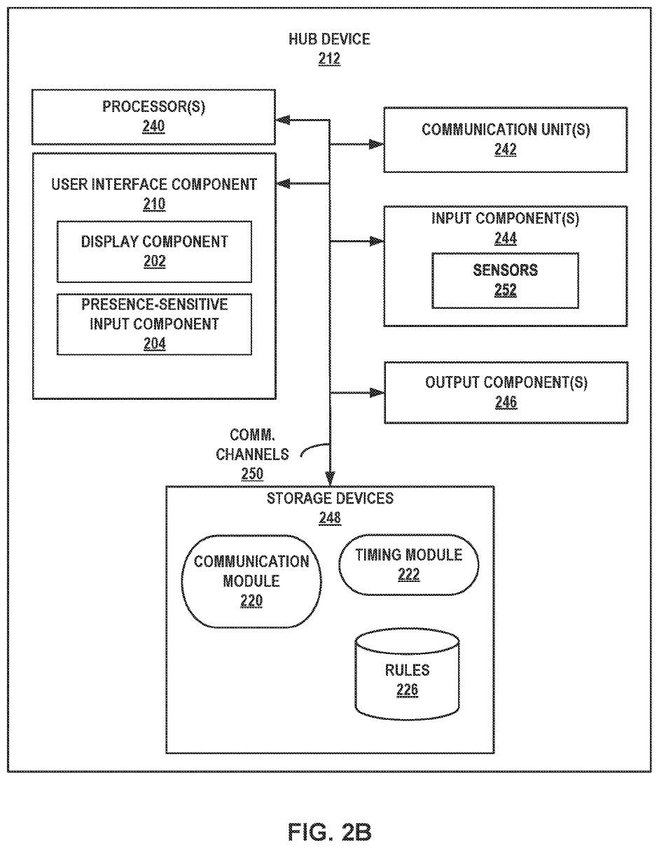

Sensor devices 14 may be configured to enroll with hub device 12. For example, sensor device 14 may be configured to exchange sensor data with hub device 12 and/or be controlled by hub device 12. Sensor devices 14 may be configured to collect or generate sensor data and transmit the sensor data to hub device 12 for processing. In some examples, sensor device 14 may include a controllable device. A controllable device may be configured to perform a specified function when the controllable device receives instructions (e.g., a command or other programming) to perform the function from hub device 12. Examples of different types of sensor devices 14 are included in the description of FIG. 2. Sensor devices 14 may include either a wired connection to an electric power grid or an internal power source, such as a battery, supercapacitor, or another internal power source.

Processing circuitry 15 may be configured to communicate with sensor devices 14 using one or more wireless communication protocols and one or more frequency bands (e.g., two different frequency bands). Examples of wireless communication protocols may include, but not limited to, a low-power wireless connection protocol, a high-bandwidth connection protocol, or a local area networking protocol. Examples of a low-power connection protocol may include, but are not limited to, IEEE 802.15.4, a low power protocol using a 900 MHz frequency band, or another low-power connection protocol. As used herein, IEEE 802.15.4 may include any standard or specification compliant with IEEE 802.15.4, such, as for example, Zigbee™, ISA100.11a™, WirelessHART™, MiWi™, 6LoWPAN™, Thread™, SNAP™, and other standards or specifications that are compliant with IEEE 802.15.4. That is, for example, IEEE 802.15.4 should be interpreted herein as including implementations relying only on the IEEE 802.15.4 standard as well as implementations that build upon the IEEE 802.15.4 standard with additional specifications, such as, for example, Zigbee™. Examples of a high-bandwidth connection protocol may include, for example, BLUETOOTH (e.g., classic BLUETOOTH, BLUETOOTH low energy, etc.). Examples of a local area networking protocol may include, for example, Wi-Fi™ (e.g., IEEE 802.11 a/b/g/n/ac, etc.).

Although FIG. TA shows hub device 12 as directly connected to sensor devices 14, in some examples, system 10 may include one or more repeater nodes that are each configured to act as an intermediary or “repeater” device. For example, sensor device 14A may output first data in accordance with Wi-Fi™ to a first repeater device, which outputs the first data to hub device 12. In this example, sensor device 14B may output second data in accordance with BLUETOOTH to a second repeater device, which outputs the second data to hub device 12. The first repeater device and the second repeater device may be the same device (e.g., a device configured to communicate in accordance with BLUETOOTH and in accordance with Wi-Fi™) or may be separate devices.

Processing circuitry 15 may be configured to use TDMA for communication in system 10. For example, a Wi-Fi™ network of a smart home system, a BLUETOOTH network of the smart home system, and an IEEE 802.15.4 network of the smart home system may operate at a 2.4 GHz frequency (e.g., within a band of frequencies comprising 2.4 GHz). In this example, processing circuitry 15 may register each of devices 14 to a slot of a superframe. For example, processing circuitry 15 may allocate sensor device 14A to a first slot of a superframe 16, also referred to herein as simply “superframe 16,” for a group of devices and allocate sensor device 14N to a second slot of superframe 16 for a group of devices. Processing circuitry 15 may “output” superframe 16 by outputting a beacon signaling the beginning of the superframe. Each one of sensor devices 14 may synchronize with the beacon and output data according to the slots defined by the superframe. In some examples, processing circuitry 15 may periodically output superframe 16 to allow sensor devices 14 to output data.

Hub device 12 may allocate multiple devices to a single slot of a superframe, but possibly at different portions of the single slot. For example, hub device 12 may allocate sensor device 14A to a first 4 ms portion of an IEEE 802.15.4 slot and allocate sensor device 14N to a second 4 ms portion of the IEEE 802.15.4 slot that is different from the first 4 ms portion of the IEEE 802.15.4 slot. In some examples, hub device 12 may allocate sensor device 14A to a first channel (e.g., 2.402 GHz) of a BLUETOOTH slot and allocate sensor device 14N to a second channel (e.g., 2.479 GHz) of the BLUETOOTH slot that is different from the first channel.

Processing circuitry 15 may use multiple superframes and/or a single superframe with slots allocated to device communication at different frequency bands. For example, processing circuitry 15 may allocate sensor device 14A to a slot of a first superframe for a first group of devices and allocate sensor device 14N to a slot of a second superframe for a second group of devices. Processing circuitry 15 may output the first superframe by outputting a first beacon signaling the beginning of the first superframe. In response to the first beacon, sensor device 14A may output data according to the slots defined by the first superframe while sensor device 14N refrains from outputting data during the first superframe. In this example, processing output the second superframe by outputting a second beacon signaling the beginning of the second superframe. In response to the second superframe, sensor device 14A may refrain from outputting data and sensor device 14B may output data according to the slots defined by the second superframe. Processing circuitry 15 may periodically output the first superframe and the second superframe to allow sensor devices 14 to output data.

In accordance with the techniques of the disclosure, processing circuitry 15 may output initial superframe 16 as a regular superframe according to a typical schedule. For instance, processing circuitry may be configured to output a superframe with a particular period between each superframe, that period ranging from as little as 5 ms between superframes, as much as 1 second or more between superframes, or in the middle at around 245 ms between superframes. So long as processing circuitry 15 does not detect any noise that would interfere with the output of the regular superframe, processing circuitry 15 may maintain that schedule of outputting superframes periodically.

In other words, hub device 12 may attempt to drift the periodic beacon either in a positive (e.g., delaying the output of the beacon) or negative (e.g., outputting the beacon sooner than planned) direction depending on certain circumstances. One such circumstance is a time at which a greater number of non-TDMA messages are received, with those non-TDMA messages coming from either a same sensor device or different sensor devices. Another circumstance where hub device 13 may attempt to drift the periodic beacon is if a certain number of sensor devices 14 are sending non-TDMA at almost at a same time. This may be an indication that these sensor devices are facing a common or same interference, potentially by being near the interference source.

Additionally, every sensor device may have a unique short address, depending on the time at which the sensor device will be reporting. Alarms and messages during a TDMA slot can be fixed, so by using the short address, hub device 12 can calculate the slot at which the particular sensor is sending the TDMA message. Depending on the slot, hub device 12 can shift beacon by considering the short address of the sensor device, the signal strength of the packet received from the sensor device at hub device 12, and/or a time at which the sensor device is sending a packet.

FIG. 1B is a conceptual diagram illustrating devices in communication using a time-shifted superframe, in accordance with some examples of this disclosure. In examples within the scope of this disclosure, processing circuitry 15 may detect noise over the network that interferes with the scheduled transmission of a regular superframe, e.g., initial superframe 16, to sensor devices 14A-14N. If processing circuitry 15 determines that there is signal interference, processing circuitry may adjust the schedule such that processing circuitry 15 outputs time-shifted superframe 18 either prior to or after the initially scheduled time. If processing circuitry 15 were to continue outputting the regularly scheduled superframes despite the noise, each of sensor devices 14A-14N would perform lengthy and battery-intensive rejoin scans to re-connect with hub device 12. Rather, by outputting time-shifted superframe 18 to avoid the noise on the network, hub device 12 can maintain the operational and communicational efficiency of system 10 and efficiently utilize the batteries of each of sensors 14A-14N.

FIG. 2A is a conceptual block diagram illustrating a networked system 20, which may be one example of the networked system 10 of FIG. 1, in accordance with some examples of this disclosure. System 20 includes hub device 12, thermostat 24A, thermostat 24B (collectively, thermostats 24), indoor motion sensor 26A, outdoor motion sensor 26B (collectively, motion sensors 26), door/window contact sensor 28, air vent damper 36A, 36B, 36C (collectively, air vent dampers 36), smart doorbell 37, outdoor air sensor 38, outdoor infrared sensor 40A, indoor infrared sensor 40B (collectively, infrared sensors 40), router 33, and mobile device 32. Hub device 12 and one or more of the devices in the networked system 20 can communicate using a first frequency band (e.g., 2.4 GHz) and/or a second, different frequency band (e.g., sub 1 GHz). For example, at least one device in the networked system 20 can communicate with hub device 12 using the first frequency band while at least one other device in the networked system 20 can communicate with hub device 12 using the second, different frequency band. In another example, at least one device in the networked system 20 can selectively communication with hub device 12 using one of the first frequency band and the second, different frequency band as selected for a specific superframe. While hub device 12 is shown as a distinct component, hub device 12 may be integrated into one or more of thermostats 24, motion sensors 26, door/window contact sensor 28, air vent dampers 36, smart doorbell 37, outdoor air sensor 38, and infrared sensors 40. The various devices of system 20 are for example purposes only. For example, additional devices may be added to system 20 and/or one or more devices of system 20 may be omitted.

The system 20 is a non-limiting example of the techniques of this disclosure. Other example systems may include more, fewer, or different components and/or devices. While FIG. 2A illustrates a mobile phone, mobile device 32 may, in some examples, include a tablet computer, a laptop or personal computer, a smart watch, a wireless network-enabled key fob, an e-readers, or another mobile device. Mobile device 32 and/or router 33 may be connected to a wide area network, such as, for example, internet 34. Internet 34 may represent a connection to the Internet via any suitable interface, such as, for example, a digital subscriber line (DSL), dial-up access, cable internet access, fiber-optic access, wireless broadband access, hybrid access networks, or other interfaces. Examples of wireless broadband access may include, for example, satellite access, WiMax™, cellular (e.g., 1X, 2G, 3G™, 4G™, 5G™, etc.), or another wireless broadband access.

Central hub device 12 may be in wireless data communication with thermostats 24, motion sensors 26, door/window contact sensor 28, air vent dampers 36, smart doorbell 37, outdoor air sensor 38, and infrared sensors 40. For example, thermostats 24, motion sensors 26, door/window contact sensor 28, air vent dampers 36, smart doorbell 37, outdoor air sensor 38, and infrared sensors 40 may be directly connected to hub device 12 using one or more wireless channels according to a connection protocol, such as, but not limited to, for example, IEEE 802.15.4, BLUETOOTH, or another connection protocol.

Each of thermostats 24, motion sensors 26, door/window contact sensor 28, air vent dampers 36, smart doorbell 37, outdoor air sensor 38, and infrared sensors 40 may include either a sensor device (e.g., a device configured to collect and/or generate sensor data), a controllable device, or both, as described herein. For example, thermostats 24 may include comfort devices having sensors, such as a thermometer configured to measure an air temperature. In some examples, air vent dampers 36 may include devices located within an air vent or air duct, configured to either open or close the shutters of an air vent in response to receiving instructions from hub device 12.

Although not shown in the example of FIG. 2A, central hub device 12 may be in indirect wireless data communication (e.g., communication via a repeater node) with one or more of thermostats 24, motion sensors 26, door/window contact sensor 28, air vent dampers 36, smart doorbell 37, outdoor air sensor 38, and infrared sensors 40. For example, outdoor air sensor 38 may be indirectly connected thermostat to hub device 12 using a wireless channel according to a connection protocol, such as, but not limited to, for example, IEEE 802.15.4, BLUETOOTH, or another connection protocol. For instance, outdoor air sensor 38 may be connected to hub device 12 via thermostat 24A, outdoor infrared sensor 40A may be connected to hub device 12 via outdoor motion sensor 26B, etc.

Thermostats 24 may be configured to wirelessly transmit the temperature (e.g., sensor data) directly to hub device 12. Additionally, thermostats 24 may include controllable devices, in that they may activate or deactivate a heating, cooling, or ventilation system in response to receiving instructions from hub device 12. For example, thermostat 24A may collect temperature data and transmit the data to hub device 12. Hub device 12, in response to receiving the temperature data, may determine that a respective room is either too hot or too cold based on the temperature data, and transmit a command to thermostat 24A to activate a heating or cooling system as appropriate. In this example, each of thermostats 24 may include both sensor devices and controllable devices within a single distinct unit.

Indoor and outdoor motion sensors 26 may include security devices configured to detect the presence of a nearby mobile object based on detecting a signal, such as an electromagnetic signal, an acoustic signal, a magnetic signal, a vibration, or other signal. The detected signal may or may not be a reflection of a signal transmitted by the same device. In response to detecting the respective signal, motion sensors 26 may generate sensor data indicating the presence of an object, and wirelessly transmit the sensor data to hub device 12. Hub device 12 may be configured to perform an action in response to receiving the sensor data, such as outputting an alert, such as a notification to mobile device 32, or by outputting a command for the respective motion sensor 26 to output an audible or visual alert. In this example, each of motion sensors 26 may include both sensor devices and controllable devices within a single unit.

Door and/or window contact sensor 28 may include a security device configured to detect the opening of a door or window on which the door and/or window contact sensor 28 is installed. For example, contact sensor 28 may include a first component installed on a door or window, and a second component installed on a frame of the respective door or window. When the first component moves toward, past, or away from the second component, the contact sensor 28 may be configured to generate sensor data indicating the motion of the door or window, and wirelessly transmit the sensor data to hub device 12. In response to receiving the sensor data, hub device may be configured to perform an action such as outputting an alert, such as a notification to mobile device 32, or by outputting a command for the respective contact sensor 28 to output an audible or visual alert. In this example, contact sensor 28 may include a sensor devices and a controllable devices within a single unit.

Air vent dampers 36 may be configured to regulate a flow of air inside of a duct. For example, thermostats 24 may generate a control signal to close air vent damper 36A (e.g., when the room is not occupied). In this example, in response to the control signal, air vent damper 36 may close to prevent air from flowing from air vent damper 36A. In some examples, air vent dampers 36 may send sensor data indicating a state (e.g., open or closed) of the respective air vent damper. For instance, air vent damper 36 may output, to thermostats 24 an indication that air vent damper 36 is in an open state.

Smart doorbell 37 may be configured to provide notifications to hub device 12. For example, smart doorbell 37 may be configured to provide a notification (e.g., message) when a button (e.g., doorbell) of smart doorbell 37 is activated. In some examples, smart doorbell 37 may include motion sensor circuitry configured to generate a notification in response to motion detected near smart doorbell 37. In some examples, smart doorbell 37 may be configured to generate video content in response to motion detected near smart doorbell 37. In some examples, smart doorbell 37 may be configured to generate audio content in response to motion detected near smart doorbell 37. For instance, in response to motion detected near smart doorbell 37, smart doorbell 37 may generate video content using a camera and/or audio content using a microphone. In this instance, smart doorbell 37 may output the video content and audio content to hub device 12, which may forward the video content and/or audio content to mobile device 32.

Outdoor air sensor 38 may be configured to generate sensor data indicating, for example, a temperature, humidity, and/or quality (e.g., carbon monoxide, particulate matter, or other hazards) of the surrounding air. In some examples, outdoor air sensor 38 may wireless transmit the sensor data to hub device 12. For instance, outdoor air sensor 38 may periodically output a current or average temperature to thermostats 24 via hub device 12.

Outdoor passive infrared sensors 40 may include security devices configured to detect the presence of a nearby object, such as a person, based on detecting infrared wavelength electromagnetic waves emitted by the object. In response to detecting the infrared waves, passive infrared sensors 40 may generate sensor data indicating the presence of the object, and wirelessly transmit the sensor data to hub device 12. Hub device 12 may be configured to perform an action in response to receiving the sensor data, such as outputting an alert, such as a notification to mobile device 32, or by outputting a command for the respective passive infrared sensor 40 to output an audible or visual alert.

System 20 may include various devices, including, for example, a security device, a water heater, a water flow controller, a garage door controller, or other devices. For example, system 20 may include one or more of: a door contact sensor, a motion passive infrared (PIR) sensor, a mini contact sensor, a key fob, a smoke detector, a glass break detector, a siren, a combined smoke detector and Carbon monoxide (CO) detector, an indoor siren, a flood sensor, a shock sensor, an outdoor siren, a CO detector, a wearable medical pendant, a wearable panic device, an occupancy sensor, a keypad, and/or other devices.

In accordance with the techniques of the disclosure, hub device 12 and each of thermostats 24, motion sensors 26, door/window contact sensor 28, air vent dampers 36, smart doorbell 37, outdoor air sensor 38, and infrared sensors 40 may be configured to operate using a superframe. Initially, hub device 12 may be configured to output a superframe to each of thermostats 24, motion sensors 26, door/window contact sensor 28, air vent dampers 36, smart doorbell 37, outdoor air sensor 38, and infrared sensors 40 according to a regular, pre-defined, periodic schedule. As the various devices in system 20 operate and transmit TDMA messages and superframes, additional devices outside of system 20, such as a laptop or a mobile phone, may join the network, creating noise over the network that could interfere with the periodic transmission of superframes by hub device 12. For the ones of thermostats 24, motion sensors 26, door/window contact sensor 28, air vent dampers 36, smart doorbell 37, outdoor air sensor 38, and infrared sensors 40 that no longer receive the periodic superframes due to the additional noise, those sensor devices would initiate rejoin scans and/or output any messages that need to be sent to hub device 12 using a non-TDMA protocol.

For instance, if the noise causes smart doorbell 37 to no longer receive the superframes from hub device 12, smart doorbell 37 may either try to rejoin and reconnect with hub device 12 through retry signals, or may send messages to hub device 12 under a non-TDMA protocol. For instance, smart doorbell 37 may output an indication that video content will be sent to hub device 12 and send that video content under a non-TDMA signal. In response to hub device receiving the non-TDMA signal, hub device 12 may determine that there must be signal interference in the network. As such, hub device 12 will output a next superframe as a time-shifted superframe instead of the regularly scheduled superframe, thereby avoiding the noise introduced into the network.

FIG. 2B is a block diagram illustrating an example hub device configured to detect signal interference amongst TDMA devices, in accordance with one or more aspects of the techniques described in this disclosure. Hub device 212 of FIG. 2B is described below as an example of computing device 110 of FIG. 1. FIG. 2 illustrates only one particular example of hub device 212, and many other examples of hub device 212 may be used in other instances and may include a subset of the components included in example hub device 212 or may include additional components not shown in FIG. 2B.

Hub device 212 may be any computer with the processing power required to adequately execute the techniques described herein. For instance, hub device 212 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2B, hub device 212 includes user interface component (UIC) 210, one or more processors 240, one or more communication units 242, one or more input components 244, one or more output components 246, and one or more storage components 248. UIC 210 includes display component 202 and presence-sensitive input component 204. Storage components 248 of hub device 212 include communication module 220, timing module 222, and rules data store 226.

One or more processors 240 may implement functionality and/or execute instructions associated with hub device 212 to detect signal interference and determine whether communication module 220 and timing module 222 need to time-shift future superframes to avoid interference. That is, processors 240 may implement functionality and/or execute instructions associated with hub device 212 to output superframes in a way that optimizes efficiency and reduces lost signals for sensor devices in communication with hub device 212.

Examples of processors 240 include application processors, display controllers, auxiliary processors, one or more sensor hubs, and any other hardware configure to function as a processor, a processing unit, or a processing device. Modules 220 and 222 may be operable by processors 240 to perform various actions, operations, or functions of hub device 212. For example, processors 240 of hub device 212 may retrieve and execute instructions stored by storage components 248 that cause processors 240 to perform the operations described with respect to modules 220 and 222. The instructions, when executed by processors 240, may cause hub device 212 to detect signal interference and determine a need to time-shift future superframes to avoid interference.

Communication module 220 may execute locally (e.g., at processors 240) to provide functions associated with communicating, using communication units 242, with various sensor devices. In some examples, communication module 220 may act as an interface to a remote service accessible to hub device 212. For example, UI module 220 may be an interface or application programming interface (API) to a remote server that facilitates communication with the various sensor devices.

In some examples, timing module 222 may execute locally (e.g., at processors 240) to provide functions associated with detecting signal interference and initiating a time-shifting sequence. In some examples, timing module 222 may act as an interface to a remote service accessible to hub device 212. For example, timing module 222 may be an interface or application programming interface (API) to a remote server that detects whether a sensor device is experiencing signal interference and initiates the time-shifting sequence.

One or more storage components 248 within hub device 212 may store information for processing during operation of hub device 212 (e.g., hub device 212 may store data accessed by modules 220 and 222 and rules data store 226 during execution at hub device 212). In some examples, storage component 248 is a temporary memory, meaning that a primary purpose of storage component 248 may not be long-term storage. Storage components 248 on hub device 212 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and rules data store 226. Storage components 248 may include a memory configured to store data or other information associated with modules 220 and 222 and rules data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of hub device 212 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of hub device 212 may receive input. Examples of input are tactile, audio, and video input. Input components 244 of hub device 212, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252), including both internal sensors and connections to external sensors. Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, motion sensor, passive infrared (PIR) sensor, air temperature and/or humidity sensor, air quality (e.g., carbon monoxide or particulate matter) sensor, a door or window contact sensor, or a step counter sensor.

One or more output components 246 of hub device 212 may generate output in a selected modality. Examples of modalities may include a tactile notification, audible notification, visual notification, machine generated voice notification, or other modalities. Output components 246 of hub device 212, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 210 of hub device 212 may include display component 202 and presence-sensitive input component 204. Display component 202 may be a screen, such as any of the displays or systems described with respect to output components 246, at which information (e.g., a visual indication) is displayed by UIC 210 while presence-sensitive input component 204 may detect an object at and/or near display component 202.

While illustrated as an internal component of hub device 212, UIC 210 may also represent an external component that shares a data path with hub device 212 for transmitting and/or receiving input and output. For instance, in one example, UIC 210 represents a built-in component of hub device 212 located within and physically connected to the external packaging of hub device 212 (e.g., a screen on a mobile phone). In another example, UIC 210 represents an external component of hub device 212 located outside and physically separated from the packaging or housing of hub device 212 (e.g., a monitor, a projector, etc. that shares a wired and/or wireless data path with hub device 212).

UIC 210 of hub device 212 may detect two-dimensional and/or three-dimensional gestures as input from a user of hub device 212. For instance, a sensor of UIC 210 may detect a user's movement (e.g., moving a hand, an arm, a pen, a stylus, a tactile object, etc.) within a threshold distance of the sensor of UIC 210. UIC 210 may determine a two or three-dimensional vector representation of the movement and correlate the vector representation to a gesture input (e.g., a hand-wave, a pinch, a clap, a pen stroke, etc.) that has multiple dimensions. In other words, UIC 210 can detect a multi-dimension gesture without requiring the user to gesture at or near a screen or surface at which UIC 210 outputs information for display. Instead, UIC 210 can detect a multi-dimensional gesture performed at or near a sensor which may or may not be located near the screen or surface at which UIC 210 outputs information for display.

In accordance with one or more techniques of this disclosure, communication module 220 may receive the signal from a sensor device. Timing module 222 may determine, using the signal from the sensor device, whether the sensor device is experiencing signal interference (e.g., the sensor device is not receiving superframes output by communication module 220 due to signal interference on the network). In determining whether the sensor device is experiencing signal interference, in some instances, timing module 222 may determine if the signal received from the sensor device matches a predefined signal interference criteria stored in rules data store 226.

In some examples, the predefined signal interference criteria includes a non-TDMA type signal. In such examples, timing module 222 may determine that the sensor device is experiencing signal interference by determining that the signal received from the sensor device is the non-TDMA type signal.

In another example, the predefined signal interference criteria includes a retry signal. In such examples, timing module 222 may determine that the sensor device is experiencing signal interference by determining that the signal received from the sensor device is the retry signal.

In still other examples, the predefined signal interference criteria includes a predefined number of retry signals received from the sensor device. In such examples, timing module 222 is configured to determine that the sensor device is experiencing signal interference by determining that the signal received from the sensor device meets the predefined number of retry signals received from the sensor device. For instance, the predefined number of retry signals received from the device may be two or more retry signals.

In some instances, the predefined signal interference criteria may include two or more of the above examples of predefined signal interference criteria. For instance, the predefined signal interference criteria may include both a non-TDMA type signal and a retry signal. In such instances, timing module 222 is configured to determine that the sensor device is experiencing signal interference by determining that the signal received from the sensor device is both the non-TDMA type signal and the retry signal.

In response to determining that the device is not experiencing signal interference, communication module 220 may output a superframe including a first beacon at a first time, with the first beacon indicating a starting of the superframe. Conversely, in response to determining that the device is experiencing signal interference, communication module 220 may output a time-shifted superframe including a second beacon at a second time that is different than the first time, with the second beacon indicating a starting of the time-shifted superframe. In some examples, communication module 220 may use a same channel number to output each of the superframe and the time-shifted superframe, regardless of which of the superframe or the time-shifted superframe is ultimately output by communication module 220. Similarly, in some examples, while the first beacon may further indicate a group number assigned to the sensor device, the second beacon may also further indicate a group number assigned to the sensor device.

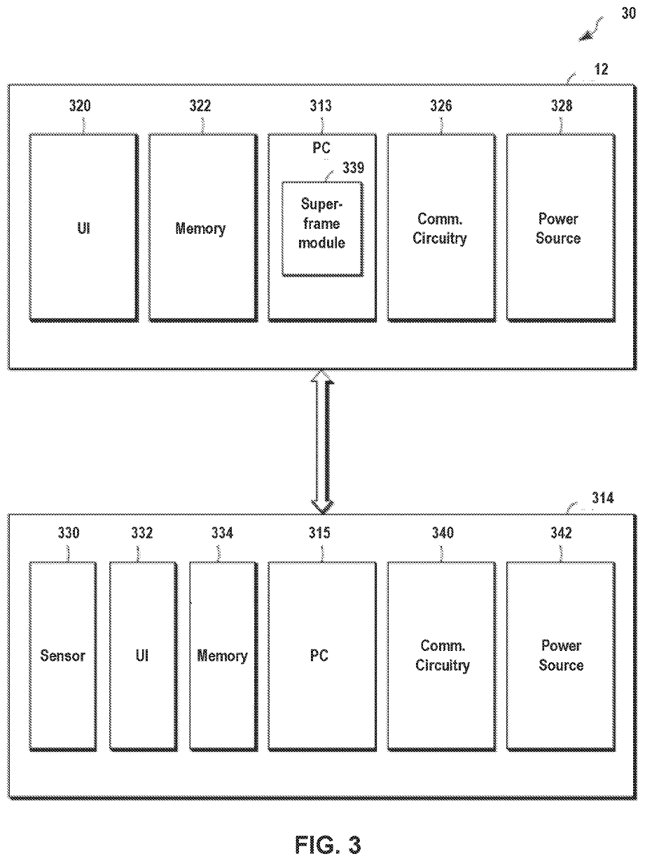

FIG. 3 is a conceptual block diagram of the hub device 12 and the sensor device 14, in accordance with some examples of this disclosure. System 30 may be an example of any of the previous systems 10, 20, or another system. System 30 includes hub device 12 and sensor device 14.

Hub device 12 may include at least a user interface (UI) 320, a memory 322, processing circuitry (PC) 313, communication circuitry 326 (“COMM. CIRCUITRY”), and a power source 328. UI 320 is configured to receive data input from, or output data to, a user. For example, UI 320 may include a display screen, such as a touchscreen, keyboard, buttons, microphone, speaker, camera, or any other user input/output device. Other examples of UI 320 are possible. For example, during an initial setup process, hub device 12 may “scan” a local proximity in order to identify one or more other devices (e.g., devices having recognizable wireless communication capabilities, such as an ability to communicate wirelessly at a second, different frequency band), and then output for display on a display screen a list of the discovered devices for selection by a user. Via UI 320, a user may also specify one or more parameters in order to control or otherwise manage a comfort and/or security system within a building and the surrounding premises. For example, via UI 320, a user may specify one or more air temperature settings or security settings, such as access codes and/or authorized users.

Hub device 12 includes a memory 322 configured to store data, as well as instructions that, when executed by processing circuitry 313, cause hub device 12 to perform one or more techniques in accordance with this disclosure. Communication circuitry 326 may include components, such as an antenna, configured to wirelessly transmit and receive data according to one or more wireless communication protocols. For example, communication circuitry 326 may be configured to transmit and/or receive data according to the IEEE 802.15.4 protocol, Wi-Fi™, and/or the BLUETOOTH protocol where appropriate, according to one or more constraints of the respective data communication protocols (e.g., communication range, energy requirements, etc.). As an additional example, communication circuitry 326 may be configured to transmit and/or receive data using each of a first frequency band and a second, different frequency band.

Power source 328 may include a wired connection to an electric power grid, due to the energy-intensive operations performed by hub device 12. However, in some examples, power source 328 may additionally or alternatively include an internal power source, such as a battery or supercapacitor. In the example of FIG. 3, hub device 12 omits a sensor, however, in some examples, hub device 12 may further include one or more sensors. Additionally, hub device 12 may be configured as a repeater node.

Sensor device 14 may be configured to wirelessly communicate with hub device 12. Sensor device 14 may include an incorporated sensor 330, a UI 332, a memory 334, processing circuitry (PC) 315, communication circuitry 340, and a power source 342. In some examples, sensor device 14 may include an incorporated sensor device, such as a motion sensor; passive infrared (PIR) sensor; air temperature and/or humidity sensor; air quality (e.g., carbon monoxide or particulate matter) sensor; or a door or window contact sensor, as non-limiting examples. Processing circuitry 313 may include wireless protocol selection module 339 that may be configured to select a first wireless protocol or a second wireless protocol for establishing a wireless connection. In some examples, wireless protocol selection module 339 may be configured to select between three or more wireless protocols for establishing a wireless connection. In addition or alternatively, processing circuitry 313 may include a frequency band selection module that may be configured to select first and second different frequency bands to be used for wireless communication.

UI 330 is configured to receive data input from, or output data to, a user. For example, UI 330 may include a display screen, such as a touchscreen, keyboard, buttons, microphone, speaker, camera, or any other user input/output device. Other examples of UI 330 are possible. For example, during an initial setup process, sensor device 14 may “scan” a local proximity in order to identify one or more hub devices and/or other devices (e.g., devices having recognizable wireless communication capabilities), and then output for display on a display screen a list of discovered devices for selection by a user. Via UI 330, a user may also specify one or more parameters in order to control or otherwise manage a comfort and/or security system within a building and the surrounding premises. For example, via UI 330, a user may specify one or more air temperature settings (e.g., for a thermostat) or security settings, such as access codes and/or authorized users. Sensor device 14 includes a memory 334 configured to store data, as well as instructions that, when executed by processing circuitry 315, cause sensor device 14 to perform one or more techniques in accordance with this disclosure.

Processing circuitry 315 and hub device 12 may exchange network parameters for pairing a BLUETOOTH channel. For example, processing circuitry 315 may determine (e.g., receive from hub device 12 or generate for output to hub device 12), one or more of. (1) a media access control (MAC) address of host device 22 and a MAC address of thermostat 24A; (2) a real time-point in time for the transfer to start (or offset from 802.15.4 start command); (3) an indication of a starting frequency; (4) an indication of a hop set; (5) a connection interval; or (6) a connection latency.

For example, processing circuitry 315 and hub device 12 may exchange a MAC address for device 12 and a MAC address for sensor device 14. In this example, communication circuitry 326 and communication circuitry 340 may be configured to establish a BLUETOOTH channel between the MAC address for hub device 12 and the MAC address for sensor device 14.

In some examples, processing circuitry 315 and hub device 12 may exchange an indication of a particular time to establish the BLUETOOTH channel. In this example, communication circuitry 326 and communication circuitry 340 may be configured to establish the BLUETOOTH channel between hub device 12 and sensor device 14 at the particular time.

For example, processing circuitry 315 and hub device 12 may exchange an indication of a starting frequency to establish the BLUETOOTH channel. In this example, communication circuitry 326 and communication circuitry 340 may be configured to establish a BLUETOOTH channel between hub device 12 and sensor device 14 at the starting frequency. For instance, the BLUETOOTH channel between hub device 12 and sensor device 14 may include 40 1 MHz wide channels that are separated by 21 MHz. In this example, the starting frequency may be an indication of a particular 1 MHz wide channel (e.g., channel 0, 1, . . . 39) and communication circuitry 326 and communication circuitry 340 may be configured to establish a BLUETOOTH channel between hub device 12 and sensor device 14 at the particular 1 MHz wide channel. The various frequencies of BLUETOOTH channels of BLUETOOTH channels, while slightly different from each other, may all correspond to a frequency for a superframe (e.g., 2.4 GHz). The processing circuitry 315 and hub device 12 may exchange an indication of a particular frequency band (e.g., the first frequency band or the second, different frequency band) to be used for wireless communications therebetween.

Processing circuitry 315 and hub device 12 may exchange an indication of a hop set for the BLUETOOTH channel, the hop set indicating a sequence of frequencies. In this example, communication circuitry 326 and communication circuitry 340 may be configured to establish a BLUETOOTH channel between hub device 12 and sensor device 14 to operate at the sequence of frequencies. For instance, the BLUETOOTH channel between hub device 12 and sensor device 14 may include 40 1 MHz wide channels that are separated by 2 MHz. In this example, the sequence of frequencies may be an indication of an order for switching between the 1 MHz wide channels (e.g., channel 0, 1, . . . 39) and communication circuitry 326 and communication circuitry 340 may be configured to establish a BLUETOOTH channel between hub device 12 and sensor device 14 that selects a 1 MHz wide channel according to the order for switching between the 1 MHz wide channels.

In some examples, processing circuitry 315 and hub device 12 may exchange an indication of a connection interval for the BLUETOOTH channel. In this example, communication circuitry 326 and communication circuitry 340 may be configured to establish a BLUETOOTH channel between hub device 12 and sensor device 14 to operate at the connection interval. For instance, rather than exchanging data at any time on the BLUETOOTH channel between hub device 12 and sensor device 14, the BLUETOOTH channel between hub device 12 and sensor device 14 may be configured to initiate a transfer of data on BLUETOOTH channel between hub device 12 and sensor device 14 at the connection interval.

Processing circuitry 315 and hub device 12 may exchange an indication of a connection latency for the BLUETOOTH channel. In this example, communication circuitry 326 and communication circuitry 340 may be configured to establish a BLUETOOTH channel between hub device 12 and sensor device 14 to operate at the connection latency. For instance, rather than exchanging data at any time or at a connection interval on the BLUETOOTH channel between hub device 12 and sensor device 14, the BLUETOOTH channel between hub device 12 and sensor device 14 may be configured to initiate a transfer of data on BLUETOOTH channel between hub device 12 and sensor device 14 at a latency interval of sensor device 14 or hub device 12. This latency interval may be selected to reduce a time a radio of sensor device 14 and/or hub device 12 listens for data (further from a connection interval), which may reduce a power consumption of sensor device 14 and/or hub device 12 compared to systems that omit a latency interval or use a zero latency interval.

Processing circuitry 315 and hub device 12 may exchange an indication of antenna information for a plurality of antennas at sensor device 14. In this example, communication circuitry 326 and communication circuitry 340 may be configured to select a particular antenna from the plurality of antennas based on the antenna information and to establish a BLUETOOTH channel between hub device 12 and sensor device 14 using the particular antenna.

Hub device 12 and sensor device 14 may be configured to operate using a superframe. For example, sensor device 14 may output an enrollment signal to hub device 12, which in some cases can include an indication of a frequency band at which the sensor device 14 desires to communicate with the hub device 12. Hub device 12 may assign sensor device 14 a group number and output an indication of the group number to sensor device 14. Hub device 12 may then control a timing of communications using the superframe. For example, hub device 12 may specify a start of a superframe using a beacon and identify devices that may communicate by specifying a group assigned to the superframe. In this way, sensor device 14 may determine when to output data. For example, sensor device 14 may, in response to a beacon output by hub device 12 indicating the group number assigned to sensor device 14, output data in accordance with the superframe.

Processing circuitry 315 and/or communication circuitry 340 may output a signal. Communication circuitry 326 may receive the signal from sensor device 314. Superframe module 339 may determine, using the signal from sensor device 314, whether sensor device 314 is experiencing signal interference (e.g., sensor device 314 is not receiving superframes output by superframe module 339 due to signal interference on the network). In determining whether sensor device 314 is experiencing signal interference, in some instances, superframe module 339 may determine if the signal received from sensor device 314 matches a predefined signal interference criteria.

In some examples, the predefined signal interference criteria includes a non-TDMA type signal. In such examples, superframe module 339 may determine that sensor device 314 is experiencing signal interference by determining that the signal received from sensor device 314 is the non-TDMA type signal.

In another example, the predefined signal interference criteria includes a retry signal. In such examples, superframe module 339 may determine that sensor device 314 is experiencing signal interference by determining that the signal received from sensor device 314 is the retry signal.

In still other examples, the predefined signal interference criteria includes a predefined number of retry signals received from sensor device 314. In such examples, superframe module 339 is configured to determine that sensor device 314 is experiencing signal interference by determining that the signal received from sensor device 314 meets the predefined number of retry signals received from sensor device 314. For instance, the predefined number of retry signals received from the device may be two or more retry signals.

In some instances, the predefined signal interference criteria may include two or more of the above examples of predefined signal interference criteria. For instance, the predefined signal interference criteria may include both a non-TDMA type signal and a retry signal. In such instances, superframe module 339 is configured to determine that sensor device 314 is experiencing signal interference by determining that the signal received from sensor device 314 is both the non-TDMA type signal and the retry signal.

In response to determining that the device is not experiencing signal interference, superframe module 339 may output a superframe including a first beacon at a first time, with the first beacon indicating a starting of the superframe. Conversely, in response to determining that the device is experiencing signal interference, superframe module 339 may output a time-shifted superframe including a second beacon at a second time that is different than the first time, with the second beacon indicating a starting of the time-shifted superframe. In some examples, superframe module 339 may use a same channel number to output each of the superframe and the time-shifted superframe, regardless of which of the superframe or the time-shifted superframe is ultimately output by superframe module 339. Similarly, in some examples, while the first beacon may further indicate a group number assigned to sensor device 314, the second beacon may also further indicate a group number assigned to sensor device 314.

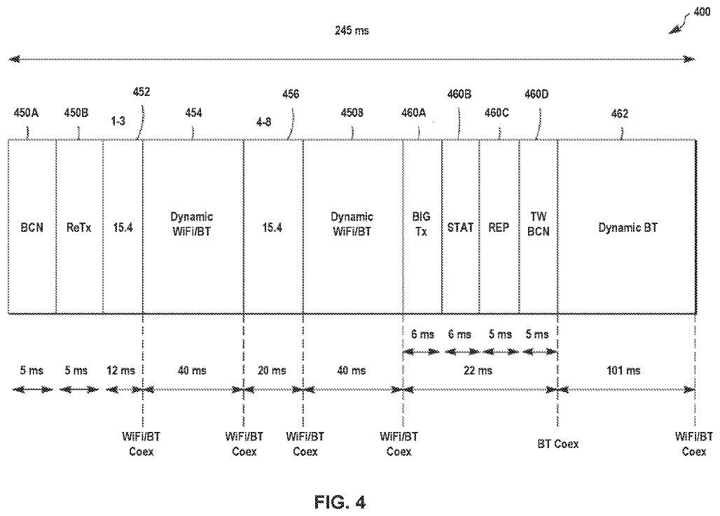

FIG. 4 is a conceptual block diagram of a first example of slots for a superframe, for instance a regularly scheduled superframe or a time-shifted superframe, in accordance with some examples of this disclosure. Thus, the superframe 400 can be descriptive of either type of superframe (the initial superframe or the time-shifted superframe). This is because hub device 12 does not necessarily change the contents of the superframe when time-shifting the superframe, nor does hub device 12 necessarily change the channel or manner of transmission for superframe 400. Rather, in various embodiments, hub device 12 can merely change the timing at which it outputs superframe 400.

The superframe 400 can include the slots as allocated to communications using a first frequency band. As shown, the superframe 400 may include a beacon slot 450A (“BCN 450A”) and a retransmission slot 450B (“ReTx”), which may be collectively referred to here as beacon slot 450A. The order of slots shown in FIG. 4 is for example purposes only. Timing shown in FIG. 4 is for example purposes only. For example, the superframe 400 may be shorter than 245 ms or longer than 245 ms. The superframe 400 is illustrated for example purposes only. For example, a superframe may include different slots (e.g., one or more slots may be removed and/or one or more slots may be added) and/or may include slots of different widths (e.g., different durations) than superframe 400.

Beacon slot 450A may mark the beginning of superframe 400. Beacon slot 450A may be used by end devices (e.g., sensor devices 14) to synchronize to the coordinator (e.g., hub device 12). As such, all devices in the system may synchronize to a master clock of the coordinator (e.g., hub device 12) thus forming a time synchronized networking system. Beacon slot 450A may include information that is used by the end devices to understand the system status, respond to commands, or other information, such as a frequency band at which a device (e.g., sensor device 14) will be communicating. The duration of beacon slot 450A may be 5 ms. The order of beacon slot 450A and a retransmission slot 450B shown in FIG. 4 is for example purposes only. Beacon slot A 450 may include additional or fewer slots. In some examples, the timing of beacon slot 450A may be less than 5 ms or more than 5 ms.

Retransmission slot 450B may be used for any non-enrolled (e.g., new) devices to associate with a coordinator (e.g., hub device 12) and thus become part of a personal area network (PAN), such as system 10, system 20, system 30 or another system. Once the enrollment mode is disabled, end devices of the previous superframe group may use retransmission 450B to attempt retransmission. The duration of retransmission slot 450B may be 5 ms.

15.4 slots 452 and 456 may be used for communications compliant with IEEE 802.15.4. In an example, there may be up to 2 or 4 15.4 slots in a superframe, however, other examples may use other combinations. Each slot may include sub-slots comprising a duration of, for example, 2 ms, 4 ms, 5, ms, etc. End devices (e.g., sensor devices 14) may use 15.4 slots 452 and 456 to transmit an alarm message, a status message, a Redlink™ network protocol (RNP) message, a supervision message, or other information. The total duration of each of 15.4 slot 452 and 15.4 slot 456 time segment may be, for example, 32 ms or 64 ms. The media access protocol for 15.4 slots 452 and 456 used may be TDMA. If a sensor device is not enrolled in a 15.4 slot, hub device 12 may allocated the 15.4 slots to Wi-Fi™ or BLUETOOTH.

Dynamic Wi-Fi™ BLUETOOTH slot 454 (“DYNAMIC Wi-Fi™/BT 454”) and dynamic Wi-Fi™ BLUETOOTH slot 458 (“DYNAMIC Wi-Fi™/BT 458”) may be referred to herein as a Wi-Fi™ coexistence time segments. A Wi-Firm time segment may be used by a Wi-Fi™ module populated on a thermostat device to transmit different types of network packets. Dynamic Wi-Fi™ BLUETOOTH slot 454, 458 may include alarm messages from the thermostat device to the central monitoring station, video streaming packets from one Wi-Fi™ client (e.g., camera or video capable sensor video/image) to another (e.g., GUI based touch screen/Cloud, etc.). The Wi-Fi™ might be operating in different modes: (a) Wi-Firm Client, (b) Wi-Fi™—AP, (c) Wi-Fi™—Hybrid. Wi-Fi™ slots may be dynamic, these slots may be shared to BLUETOOTH or Wi-Fi™ depending on different modes of superframes. As shown, dynamic Wi-Fi™ BLUETOOTH slot 454 and dynamic Wi-Fi™ BLUETOOTH slot 458 may be 40 ms.

Big TX/RX Slot 460A (“Big Tx 460A”), status slot 460B, repeater slot 460C (“REP 460C”), and twin beacon slot 460D (“TW BCN 460D”) may be collectively referred to herein as beacon slot B 460. The order of Big TX/RX Slot 460A, status slot 460B, repeater slot 460C, and twin beacon slot 460D shown in FIG. 4 is for example purposes only. Beacon slot B 460 may include additional or fewer slots.

Big TX/RX Slot 460A may include one or more large data transmit slots that are each more than 10 bytes and may be up to 96 bytes. An access point (e.g., hub device 12) may be able to send any data to any device using this slot. Data can be unicast, broadcast or groupcast depending on a type of request. This mode of communication may be indicated in beacon A slot 450. Big TX/RX Slot 460A may be used to send over-network download (OND) blocks to sensor devices or to set configure sensor devices. If the TX/RX Slot 460A is not active, hub device 12 may allocate time for TX/RX Slot 460A to Wi-Fi™ to increase time for Wi-Fi™ communication.

Status slot 450B may share a status with some or all of sensor devices 14. Status slot 450B may not be active at every instance of a superframe. Status slot 450B may include data that is unicast, broadcast, or groupcast depending on a type of request. This mode of communication may be indicated in beacon A slot 450.

Repeater slot 460C may be configured for sending and receiving data from repeaters of a large/small data. An access point (e.g., hub device 12) may be able to send any data to any repeater using repeater slot 460C. Data included in repeater slot 460C can be unicast, broadcast or groupcast depending on a type of request. This mode of communication may be indicated in beacon A slot 450.

Twin beacon slot 460D may be called information beacon/twin beacon. Payload of twin beacon 460D may be almost same as beacon slot 450A with some exceptions but may operate in a different channel referred to herein as an information channel. Twin beacon slot 460D may be present in all superframes irrespective of modes of operation. Twin beacon slot 460D may be used by all the end devices to synchronize to the coordinator only if they lose connection with an access point using beacon slot 450A. Twin beacon slot 460D may not be used for synchronization of time but may be used to share the information like what is the operation channel or frequency hopping sequence or a next channel of communication. The duration of twin beacon slot 460D may be 5 ms. In some examples, the timing of twin beacon slot 460D may be less than 5 ms or more than 5 ms.

Dynamic BLUETOOTH slot 462 may be dedicated to BLUETOOTH by an access Point (e.g., hub device 12). Dynamic BLUETOOTH slot 462 may support mobile and sensor communication. Allocation of dynamic BLUETOOTH slot 462 may vary with different modes of comfort/security superframes as described further below. As shown, dynamic BLUETOOTH slot 462 may be 101 ms. In some examples, the timing of dynamic BLUETOOTH slot 462 may be less than 101 ms or more than 101 ms.

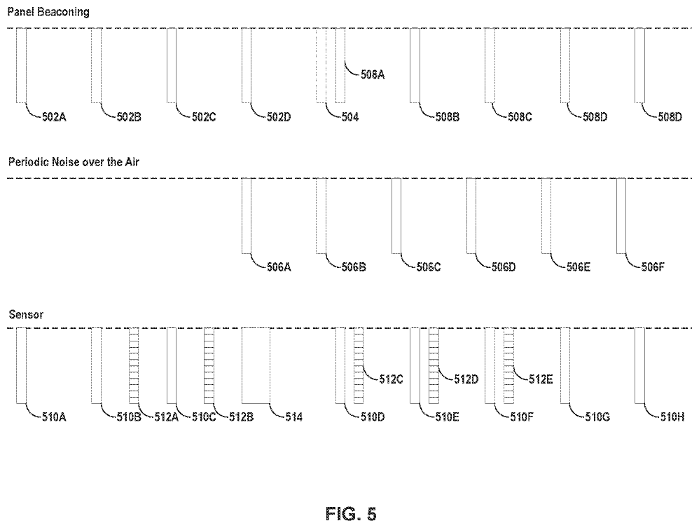

FIG. 5 is a conceptual timing diagram for beacons output in accordance with some examples of this disclosure. The graph under the label “Panel Beaconing” may describe functions of a hub device, such as hub device 12 of FIG. 1 or hub device 212 of FIG. 2B. The graph under the label “Sensor” may describe functions of a sensor device, such as any of sensor devices 14A-14N. The graph under “Periodic Noise over the Air” may describe functions of other computing devices that may operate on a same network as hub device 12 and sensor devices 14A-14N.

In accordance with FIG. 5, hub device 12 may output superframe 502A, which is received by sensor device 14A. Superframe 502A causes periodic wakeup 510A in sensor device 14A to confirm that the connection between hub device 12 and sensor device 14A is maintained. This process repeats for superframe 502B and periodic wakeup 510B.

After periodic wakeup 510B, sensor device 14A sends TDMA message 512A, which ultimately is received by hub device 12. This process repeats for superframe 502C, periodic wakeup 510C, and TDMA message 512B.

Eventually, another computing device on the network outputs noise 506A at a time that would coincide with superframe 502D. Sensor device 14A expects superframe 502D, but does not receive superframe 502D due to noise 506A. Since sensor device 14A does not receive superframe 502D, sensor device 14A initiates signal 514 that can include either outputting a retry signal or a non-TDMA signal.

Hub device 12 receives signal 514 and determines that it should time-shift one or more future superframes. Rather than outputting a regularly scheduled superframe at initial superframe timeslot 504, as hub device 12 detects noise 506B at that initial timeslot, hub device 12 instead outputs time-shifted superframe 508A instead. Since sensor device 14A received time-shifted superframe 508A, sensor device 14A executes periodic wakeup 510D. Sensor device 14A then outputs TDMA message 512C, which hub device 12 receives.

Due to the periodic noise 506C-506F, hub device 12 can continue to output time-shifted superframes 508B-508D rather than the initially scheduled superframes. Sensor device 14A continues with periodic wakeups 510E-510H and sends TDMA messages 512D-512E.

Without the techniques described herein to time-shift superframes 508A-508D, sensor 14A would initiate rejoin scan 514 at every instance it would expect to receive a superframe in accordance with the initial schedule of superframes. Without receiving these superframes, sensor device 14A would send a non-TDMA message to hub device 12, and again scan for the superframe at the expected time even though it is blocked by one of noise 506A-506F. This additional time scanning and sending non-TDMA messages would drain the battery of sensor device 14A, reducing the efficiency of the sensor and polluting the network with additional traffic, messages, and scans. In this way, the techniques described herein provide a practical application by improving both the operating efficiency of both hub device 12 and sensor device 14A, as well as improve the functioning and efficiency of the network as a whole.

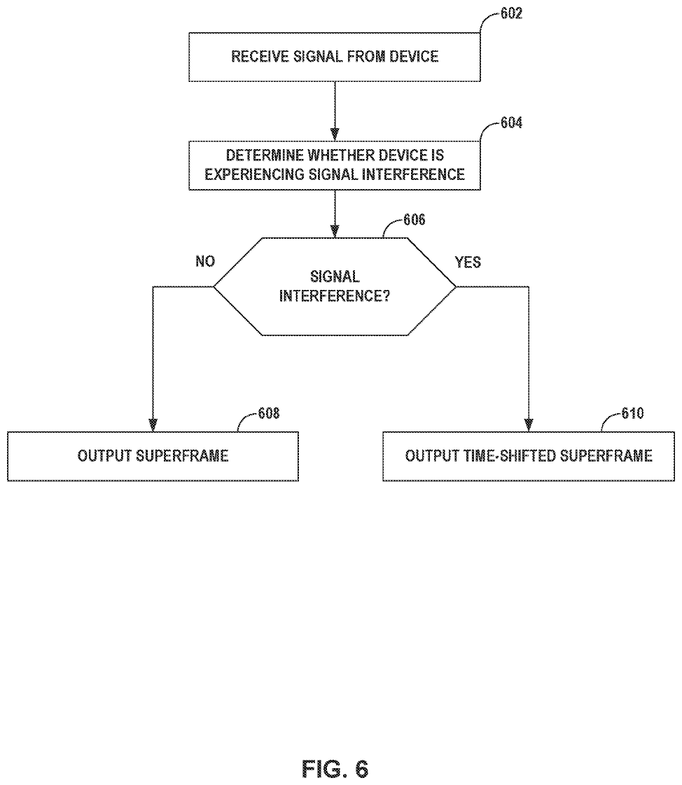

FIG. 6 is a flow chart illustrating an example mode of operation. The techniques of FIG. 6 may be performed by one or more processors of a computing device, such as hub device 12 of FIG. 1 and/or hub device 212 illustrated in FIG. 2B. For purposes of illustration only, the techniques of FIG. 5 are described within the context of hub device 12 of FIG. 1, although computing devices having configurations different than that of hub device 12 may perform the techniques of FIG. 6.

In step 602, processing circuitry 15 receives a signal from a device of the plurality of devices (e.g., any of sensor devices 14A-14N).

In step 604, processing circuitry 15 determines, using the signal from any of sensor devices 14A-14N, whether the device is experiencing signal interference. In certain examples, processing circuitry 15 determines whether the device is experiencing signal interference by determining if the signal received from the device matches a predefined signal interference criteria. The predefined signal interference criteria may be any one or more of a non-TDMA type signal, a retry signal, or a predefined number of retry signals.

In step 608, in response to determining that the device is not experiencing signal interference (“NO” branch of 606), processing circuitry 15 outputs a superframe including a first beacon at a first time, wherein the first beacon indicates a starting of the superframe. In step 610, in response to determining that the device is experiencing signal interference (“YES” branch of step 606), processing circuitry 15 outputs a time-shifted superframe including a second beacon at a second time that is different than the first time, wherein the second beacon indicates a starting of the time-shifted superframe. In certain examples, processing circuitry 15 uses a same channel number to output each of the superframe from step 608 and the time-shifted superframe from step 610. In certain examples, the first beacon and the second beacon also each indicate a group number assigned to each device of the plurality of devices.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. An apparatus for communication with a plurality of devices using time divisional multiple access (TDMA), the apparatus comprising processing circuitry configured to:
receive a signal from a device of the plurality of devices;
determine, using the signal from the device, whether the device is experiencing signal interference;
in response to determining that the device is not experiencing signal interference, output a superframe including a first beacon at a first time, wherein the first beacon indicates a starting of the superframe; and
in response to determining that the device is experiencing signal interference, output a time-shifted superframe including a second beacon at a second time that is different than the first time, wherein the second beacon indicates a starting of the time-shifted superframe.

2. The apparatus of claim 1, wherein determining, using the signal from the device, whether the device is experiencing signal interference comprises determining if the signal received from the device matches a predefined signal interference criteria.

3. The apparatus of claim 2, wherein the predefined signal interference criteria includes a non-TDMA type signal, and wherein the processing circuitry is configured to determine that the device is experiencing signal interference by determining that the signal received from the device is the non-TDMA type signal.

4. The apparatus of claim 2, wherein the predefined signal interference criteria includes a retry signal, and wherein the processing circuitry is configured to determine that the device is experiencing signal interference by determining that the signal received from the device is the retry signal.

5. The apparatus of claim 2, wherein the predefined signal interference criteria is a predefined number of retry signals received from the device, and wherein the processing circuitry is configured to determine that the device is experiencing signal interference by determining that the signal received from the device meets the predefined number of retry signals received from the device.

6. The apparatus of claim 5, wherein the predefined number of retry signals received from the device is two or more retry signals.

7. The apparatus of claim 2, wherein the predefined signal interference criteria includes both a non-TDMA type signal and a retry signal, and wherein the processing circuitry is configured to determine that the device is experiencing signal interference by determining that the signal received from the device is both the non-TDMA type signal and the retry signal.

8. The apparatus of claim 1, wherein the processing circuitry is configured to use a same channel number to output each of the superframe and the time-shifted superframe.

9. The apparatus of claim 1, wherein the first beacon further indicates a group number assigned to each device of the plurality of devices, and wherein the second beacon further indicates a group number assigned to each device of the plurality of devices.

10. A method comprising the steps of
receiving, at processing circuitry, a signal from a device of a plurality of devices;
determining, at the processing circuitry using the signal from the device, whether the device is experiencing signal interference;
in response to determining, at the processing circuitry, that the device is not experiencing signal interference, outputting, by the processing circuitry, a superframe including a first beacon at a first time, wherein the first beacon indicates a starting of the superframe
in response to determining, at the processing circuitry, that the device is experiencing signal interference, outputting, by the processing circuitry, a time-shifted superframe including a second beacon at a second time that is different than the first time, wherein the second beacon indicates a starting of the time-shifted superframe.

11. The method of claim 10, wherein determining, at the processing circuitry using the signal from the device, whether the device is experiencing signal interference comprises determining if the signal received from the device matches a predefined signal interference criteria.

12. The method of claim 11, wherein the predefined signal interference criteria includes a non-time divisional multiple access (TDMA) type signal, and wherein determining, at the processing circuitry, that the device is experiencing signal interference comprises determining that the signal received from the device is the non-TDMA type signal.

13. The method of claim 11, wherein the predefined signal interference criteria includes a retry signal, and wherein determining, at the processing circuitry, that the device is experiencing signal interference comprises determining that the signal received from the device is the retry signal.

14. The method of claim 11, wherein the predefined signal interference criteria is a predefined number of retry signals received from the device, and wherein determining, at the processing circuitry, that the device is experiencing signal interference comprises determining that the signal received from the device meets the predefined number of retry signals received from the device.

15. The method of claim 11, wherein the predefined signal interference criteria includes both a non-TDMA type signal and a retry signal, and wherein determining, at the processing circuitry, that the device is experiencing signal interference comprises determining that the signal received from the device is both the non-TDMA type signal and the retry signal.

16. The method of claim 10, wherein the superframe and the time-shifted superframe are output by the processing circuitry using a same channel number.

17. The method of claim 10, wherein the first beacon further indicates a group number assigned to each device of the plurality of devices, and wherein the second beacon further indicates a group number assigned to each device of the plurality of devices.

18. A system comprising:
a plurality of sensor devices; and
a hub device in communication with the plurality of sensor devices using time divisional multiple access (TDMA), the hub device comprising processing circuitry configured to:
receive a signal from a sensor device of the plurality of sensor devices,
determine, using the signal from the sensor device, whether the sensor device is experiencing signal interference,
in response to determining that the sensor device is not experiencing signal interference, output a superframe including a first beacon at a first time, wherein the first beacon indicates a starting of the superframe, and
in response to determining that the sensor device is experiencing signal interference, output a time-shifted superframe including a second beacon at a second time that is different than the first time, wherein the second beacon indicates a starting of the time-shifted superframe.

19. The system of claim 18, wherein determining, using the signal from the sensor device, whether the sensor device is experiencing signal interference comprises determining if the signal received from the sensor device matches a predefined signal interference criteria, and wherein the predefined signal interference criteria includes at least one of a non-TDMA type signal and a retry signal.

20. The system of claim 18, wherein the superframe and the time-shifted superframe are output by the processing circuitry using a same channel number.
